(19) United States
(12) Patent Application Publication
(10) Pub. No.: US 2009/0303839 A1
(43) Pub. Date: Dec. 10, 2009

(54) STRESS-BIASED CYMBALS INCORPORATING A SHAPE MEMORY ALLOY

(76) Inventors: Manoj Narayanan, Woodridge, IL (US); Robert W. Schwartz, Rolla, MO (US)

Correspondence Address: Brannon & Associates PC, 1 North Pennsylvania Street, Suite 520, Indianapolis, IN, 46204, US

(21) Appl. No.: 12/184,195

(22) Filed: Jul. 31, 2008

Related U.S. Application Data
(60) Provisional application No. 60/953,035, filed on Jul. 31, 2007.

(51) Int. Cl. H04R 17/00; H04R 31/00

(52) U.S. Cl. 367/164; 29/594

(57) ABSTRACT

A flextensional transducer, including a generally disc-shaped piezoelectric member having a generally flat top surface and a generally flat parallel bottom surface, a top electrode formed on the top surface, a bottom electrode formed on the bottom surface, a top endcap operationally connected to the top surface, and a bottom endcap operationally connected to the bottom surface. The top and bottom endcaps are formed of shape memory material. The endcap exerts a radial stress upon the generally disc-shaped piezoelectric member.

### CROSS-REFERENCE TO RELATED APPLICATIONS

This utility patent application is based on, and claims priority to, U.S. Provisional Patent Application Ser. No. 60/953,035, filed on Jul. 31, 2007.

### TECHNOLOGICAL FIELD

The novel technology relates generally to ceramic materials and, more particularly, to transducers that incorporate both flextensional and stress-biased processes.

### BACKGROUND

Cymbals are class V flextensional devices developed at the Pennsylvania State University in the late 1990's. Since their novel technology, they have been successfully used in many applications, including vibration control, underwater transduction, non-invasive drug delivery, and the like. In general, these devices consist of a piezoelectric disc poled in the thickness direction and sandwiched between two metal endcaps. The structure is typically assembled by using a room temperature curable epoxy. The metal endcaps serve two purposes. First, they act as a mechanical transformer by translating a small incident normal compressive stress into a large lateral tensile stress. This results in increased electrical output for the device. Second, when operated in the converse mode, the endcaps act as an amplifier to translate small lateral displacement into a large normal displacement.

A typical cross-section of a cymbal device with various dimensional parameters is shown in FIG. 1. Effective piezoelectric charge coefficients (d^{eff}₃₃) of ˜15,000 pC/N have been previously reported for these devices. This value is significantly higher than the 500 to 700 pC/N normally observed for the flat plate PZT disks used in cymbal fabrication. The observed high charge coefficient values in these devices are mainly attributed to the combination of the amplifying nature of the endcaps and the negative d₃₁ contribution in these devices.

Another class of flextensional transducers that was developed almost simultaneously with cymbals is stress-biased actuators. The first device of this kind was the rainbow (Reduced And INternally Biased Oxide Wafer) ceramic, developed by Haertling. These devices are produced by chemically reducing one side of a lead-containing piezoelectric ceramic from the lead zirconate titanate (PZT) or lanthanum-doped lead zirconate titanate (PLZT) families at an elevated temperature. When this composite structure is cooled to room temperature, the difference in thermal expansion coefficients between the ceramic and reduced layers creates a highly stressed dome-shaped structure. It is thought that the high tensile stress levels within the surface region of the ceramic enhances the effective piezoelectric response by enhancing 90° domain switching. This leads to a higher d₃₁ coefficient, which is the primary mechanism that contributes to the enhanced electromechanical performance of these devices.

Shape memory alloys represent a completely different, and non-piezoelectric, type of actuator under consideration for many applications. Shape Memory Alloys (SMA's) are metal alloys that can recover permanent strains when they are heated above a certain temperature. These alloys have two stable phases namely the high temperature austenite phase and the low temperature martensite phase. The martensite phase exists in either twinned or detwinned forms. A phase transition that occurs between the high and low temperature phases upon heating/cooling is responsible for the unique properties exhibited by these alloys. During cooling, in the absence of applied mechanical load, the material transforms from austenite to twinned martensite, because it is more self-accommodating. This is called the shape memory effect. The most commonly used SMA is Nitinol (Nickel Titanium Naval Ordnance Laboratory) containing nearly equal numbers of nickel and titanium atoms. The relative amounts of Ni and Ti (NiₓTi₁₋ₓ) can be varied by a few percent in order to control the phase transformation temperature between −200° C. to 110° C. These alloys have a maximum recoverable strain of approximately 8%.

There remains a need for flextensional transducers exhibiting greater electromechanical performance. The present novel technology addresses this need.

### SUMMARY

The present novel technology relates to flextensional transducer devices. One object of the present novel technology is to provide an improved flextensional transducer device. Remaining objects and advantages of the novel technology will become apparent from the following descriptions.

### BRIEF DESCRIPTION OF THE FIGURES

FIG. 1 is a cross-sectional view of a first embodiment cymbal transducer of the present novel technology.

FIG. 2 is a schematic view of an experimental setup for studying the effect of pre-stress on polarization of the transducers of FIG. 1.

FIG. 3A is a diagrammatic view of a theoretical model considered for predicting the stress applied on the PZT by the shape memory endcap during pre-stressing of the transducers of FIG. 1.

FIG. 3B is a diagrammatic view of the model of FIG. 3A.

FIG. 3C is a diagrammatic view of the model of FIG. 3A.

FIG. 4 is a plot of the calculated theoretical stress in the PZT for different initial and final cavity depths of the transducers of FIG. 1.

FIG. 5 is a plot of the measured voltage across a 1 μF capacitor connected in parallel to the device during pre-stressing of the transducers of FIG. 1.

FIG. 6 is a plot of the radial stress calculated from the measured voltage as a function of decrease in the cavity depth of the transducers of FIG. 1.

FIG. 7 is a plot of the measured hysteresis loops of the SBC at different pre-stress levels (decrease in the cavity depth) of the transducers of FIG. 1.

FIG. 8A is a first perspective view of the PZT portion of a transducer of FIG. 1 after failure showing the circumferential crack formed indicating the radial tensile nature of the pre-stress induced by the shape memory endcap.

FIG. 8B is a second enlarged partial perspective view of FIG. 8A.

FIG. 8C is a third enlarged partial perspective view of FIG. 8A.

FIG. 9 is a plot of the differential dielectric constant calculated from the measured hysteresis loops of a transducer of FIG. 1 at different pre-stress levels (decrease in the cavity depth).

FIG. 10 is a plot of the dynamic dielectric constant calculated from the measured capacitance of a transducer of FIG. 1 at different pre-stress levels (decrease in the cavity depth).

FIG. 11 is a plot of the dielectric loss of a transducer of FIG. 1 at different pre-stress levels (decrease in the cavity depth).

FIG. 12 is a plot of the impedance spectra of a transducer of FIG. 1 at different pre-stress levels (decrease in the cavity depth).

FIG. 13 is a plot of the radial resonance frequency of a transducer of FIG. 1 at different pre-stress levels (decrease in the cavity depth).

FIG. 14 is a plot of the displacement measured at the apex of a transducer of FIG. 1 at different pre-stress levels (decrease in the cavity depth).

FIG. 15 is a plot of the change in the effective d₃₃(T) of a transducer of FIG. 1 at different pre-stress level as (decrease in the cavity depth) relative to the stress-free effective d₃₃(0).

FIG. 16 is a schematic diagram of the production of a transducer of FIG. 1.

FIG. 17 is a schematic diagram of the production of a second embodiment transducer according to the present novel technology.

### DETAILED DESCRIPTION

For the purposes of promoting an understanding of the principles of the novel technology, reference will now be made to the preferred embodiments thereof, and specific language will be used to describe the same. It will nevertheless be understood that no limitation of the scope of the novel technology is thereby intended, such alterations, modifications, and further applications of the principles of the novel technology being contemplated as would normally occur to one skilled in the art to which the novel technology relates.

A number of explanations and experiments are provided by way of explanation and not by limitation. No theory of how the novel technology operates is to be considered limiting, whether proffered by virtue of description, comparison, explanation or example. Accordingly, the following examples and discussion are presented by way of guidance and explanation and not limitation.

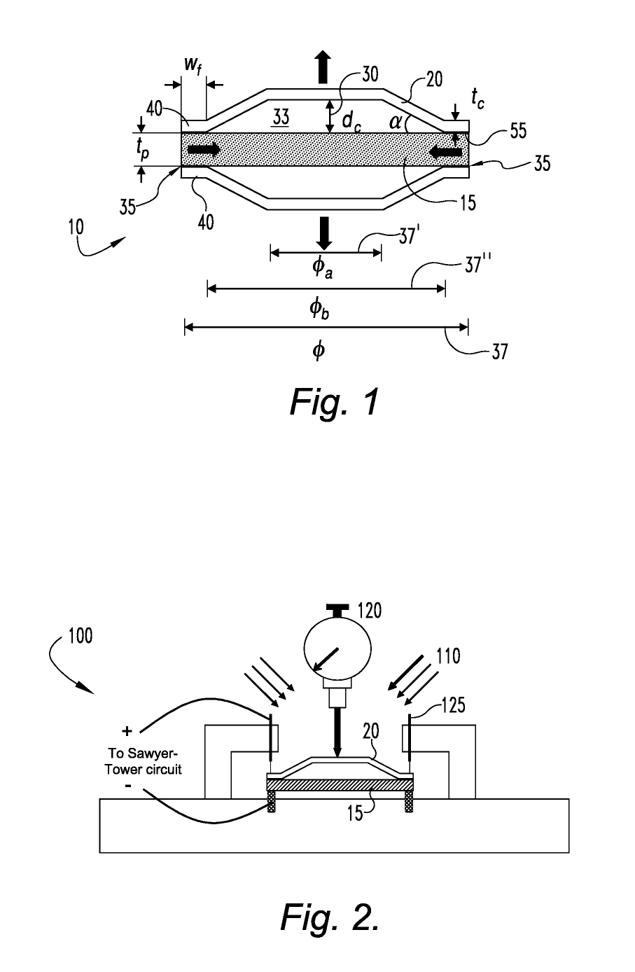

According to a first embodiment of the present novel technology as illustrated in FIGS. 1-16, the performance of flextensional devices 10, such as cymbals, may be improved by enhancing the domain wall translation contribution to device response through stress engineering of the piezoelectric layer 15 within the cymbal 10. The d₃₁ contribution in cymbals 10 is further increased by pre-stressing the active element 15 in these devices 10 to enhance extrinsic contributions (such as from domain wall motion and/or domain switching). Although tensile stresses are often considered detrimental, since they can reduce device lifetime due to enhanced mechanical fatigue, rainbow devices perform without much degradation in deformation response (<10% for devices made with PZT 5A or 5H) up to 10⁷ cycles. A transverse tensile stress may favor the a-domain orientation (polarization component parallel to the disc major surfaces) compared to the stress-free ceramic. Therefore, the tensile stress field that is perpendicular to the applied electric field contributes to enhanced 90°-domain switching in the surface region of these stress-biased devices.

A novel method of pre-stressing the electroactive element using cymbal endcaps 20 made of shape memory alloy is detailed herein. In one particular embodiment, a flat trained SMA, with an austenite finish temperature (A_{f}) of 45° C., was used to make the cymbal shaped endcap 20. After bonding the endcap 20 to the PZT disk 15, the device 10 was heated slightly above the A_{f} to recover the flat trained shape of the SMA; i.e., the cavity depth 30 of the end cap 20 decreases. This shape recovery process is opposed by the bond 35 between the flanges 40 of the endcap 20 and the PZT 15, resulting in the generation of a radial tensile stress in the PZT disk 15. It is shown that this pre-stress enhances the 90° domain switching, thus increasing the piezoelectric and dielectric response of the novel cymbal-like devices 10. The magnitude of the radial stress can be controlled by the heating time (final cavity depth), initial cavity depth and thickness of the SMA.

Alternately, SMA materials with other A_{f} values may be selected to make the cymbal endcap 20. For example, if the endcap 20 was made from an SMA material characterized by an A_{f} value of 20° C., the endcap 20 could be bonded to the PZT disc 15 at a lower temperature, such as about 15° C., and prestressing of the device 10 would be accomplished by simply bringing the device 10 to room temperature. The device 10 would enjoy the advantage of being continuously under a pre-stress condition, since the pre-stress temperature would be lower than room temperature with no separate heating step necessary.

A flat trained nitinol sheet 25 about 0.25 mm thick with an austenite finish temperature of ˜45° C. and pre-poled PZT disks 15 about 25 mm in diameter and about 0.2 mm in thickness were used in this particular embodiment. The piezoelectric disks 15 of this embodiment were made of compositions near the vicinity of the morphotropic phase boundary of PZT in the tetragonal phase at standard temperature and pressure conditions, with performance characteristics similar to PZT 5A compositions. While the disc compositions are typically chosen to be close to the morphotropic phase boundary of the piezoelectric disc material, this is not essential, and other piezoelectric compositions may be elected.

The cymbal shape for the endcap 20 was attained by stamping and cutting 50 the 0.25 mm thick nitinol sheet 25 in a specially designed steel die, but may likewise be produced by any convenient metal-forming technique. In this example, the flanges 40 of the metal endcap 20 and the surface of the electrodes 55 on the PZT disk 15 were roughened 60 with a 400 grit SiC abrasive paper to improve the bond strength; of course, such roughening is not always necessary. After the surface preparation, both the shape memory cap 20 and the PZT 15 were cleaned with acetone to remove any residual metal and SiC particles. Although the end caps 20 and piezoelectric element 15 in standard cymbal devices are typically bonded together using room temperature curable epoxy or the like, the stresses developed from the shape memory alloys tend to result in bond degradation and/or failure. In this example, cyanoacrylate adhesive was applied to the flanges 40 directly from the tip of the container. The endcap 20 was then assembled with the PZT layer 15 and bonded 70 thereto under a load of approximately 50 N applied to the flanges 40 during curing at room temperature. Any excess glue was then removed. The test devices 10 so prepared were fabricated with a single endcap 20, as opposed to the two oppositely spaced endcaps 20 typically used in the cymbals 10, because of the ease in measuring the decrease in the cavity depth 30 (pre-stress applied) of one endcap 20 following the shape memory alloy transformation. Of course, the present novel technology contemplates similar devices 10 having two oppositely disposed endcaps 20 affixed to a piezoelectric member 15.

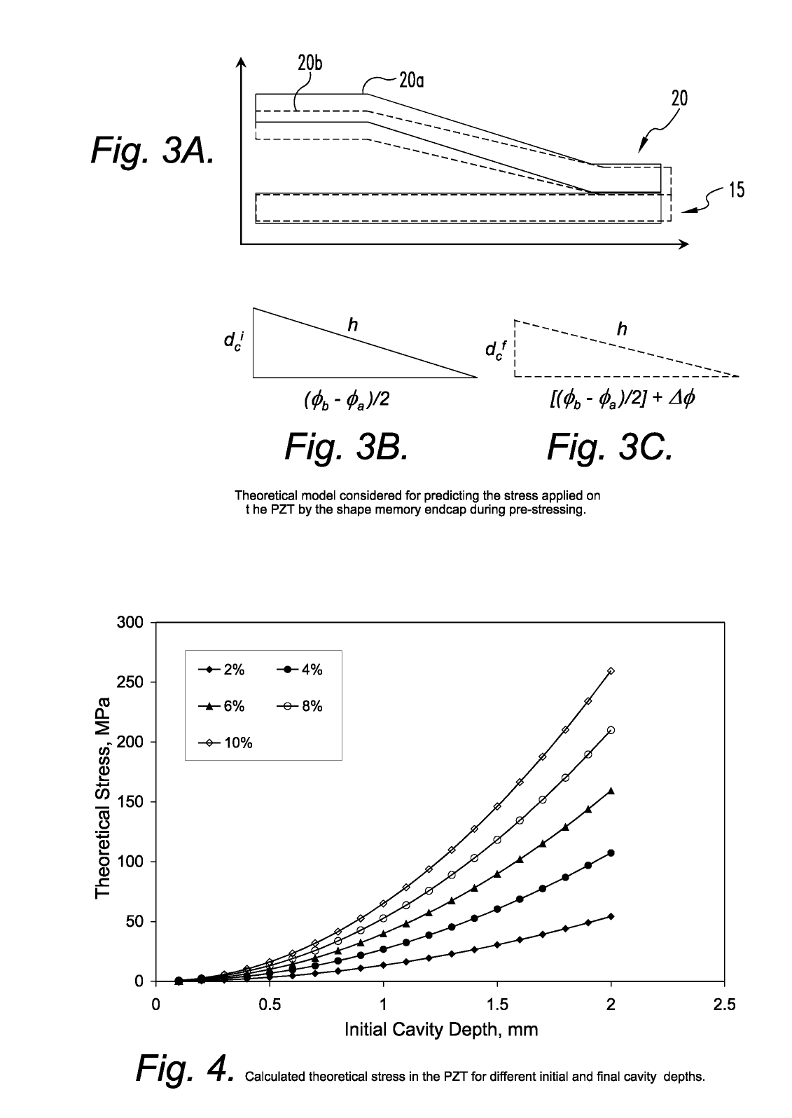

As shown in FIGS. 2 and 3, the electric polarization of the stress-free and stress-biased cymbals 10 was measured with a modified Sawyer-Tower circuit 100. In this circuit, a very low frequency AC voltage is applied to the sample device 10 and the resultant charge is determined by measuring the voltage across a large reference capacitor connected in series to the sample. A 2 kV/mm, 0.01 Hz triangular field was applied to the sample with a function generator and an amplifier (specifically a 50/750 amplifier) operated at a gain of 1:100. A high input resistance electrometer was used to measure the voltage across the 33 μF reference capacitor. A control program was written to control, acquire and record the data from the electrometer on a computer. The program records data at one second intervals so that a set of 100 data points typically represents a full electric field cycle. From the measured voltage the polarization can be calculated as

$${P}_{sample} = \frac{{UC}_{ref}}{A} \qquad ( 1 )$$

where Pₛₐₘₚₗₑ is the polarization (C/m²), U is the voltage measured across the reference capacitor (V), C_{ref} is the capacitance of the reference capacitor (33 μF), and A is the electroded area of the sample (m²).

The polarization of the initially pre-poled SBC sample was first measured by full electric field reversals (±2 kV/mm, 4 cycles) in the stress free state using the Sawyer-Tower circuit. The shape memory endcap 20 was then heated 110 to ˜45° C. with a hair dryer to pre-stress the PZT 15 while simultaneously monitoring the decrease in the cavity depth 30 with a dial micrometer 120. The electric polarization of the pre-stressed sample 10 was then measured using the same procedure discussed above approximately 2 minutes after applying the pre-stress. This measurement was repeated with steps of ˜25 μm (1 mil) decrease in the cavity depth 30, until the PZT disc 15 fractured and only the polarization response measured in the fourth cycle is reported.

The lateral stress developed within the pre-poled PZT disc 15 during pre-stressing was measured by monitoring the charge accumulated on the electrodes 55 of the sample, which was measured as a voltage across a 1 μF capacitor connected in parallel with the sample. An electrometer connected to the computer was used to measure the voltage across the capacitor. The stress applied (T₁) was then calculated from the following equations:

$$\begin{matrix}{D}_{3} = \frac{{UC}_{ref}}{A} & ( 2 ) \\ {D}_{3} = 2 {d}_{31} {T}_{1} & ( 3 )\end{matrix}$$

where D₃ is the dielectric displacement parallel to the poling direction (C/m²), U is the voltage measured across he reference capacitor (V),C_{ref} is the capacitance of the reference capacitor (1 μF), A is the electrode area of the sample (m²), d₃₁ is the lateral piezoelectric charge coefficient (˜−270 pC/N), and Ti (N/m²) is the radial stress developed within the PZT. If the cross-section of the SBC is considered, the shape memory endcaps 20 applies this tensile stress (T₁) at the two ends of the PZT disc 15 pulling it in opposite directions. This results in a net radial stress of 2T₁ in the PZT material 15. As noted earlier, the pre-stress magnitude was monitored by measuring the decrease in the cavity depth 30 with a dial micrometer 120. We also note, however, that as radial stresses develop through the shape recovery process the piezoelectric member 15 is partially depoled (evident in hysteresis loop measurements presented below). This effect will lead to a current flow (i.e., measured voltage) in the external circuit, and calculations of the magnitude of this effect suggest it contributes less than 5% to the measured voltage.

The capacitance and dielectric loss of the SBC's 10 were measured with an impedance/gain-phase analyzer at 1 kHz with an oscillator level of 0.5V. The samples 10 were held at the flanges 46 with spring loaded pogo pins 125 to reduce the effect of clamping conditions. The dynamic dielectric constant is determined from the capacitance using the general parallel plate capacitor equation. The dynamic dielectric permittivity often reported is measured with a small oscillating field (1 V/mm) and is largely dictated by the intrinsic contribution. These properties were measured as a function of pre-stress level (decrease in the cavity depth) until the PZT member 15 fractured. The impedance spectra of the SBC's 10 was measured using the same setup in the frequency range from 80 to 100 kHz to determine the resonance and anti-resonance frequency of the radial mode of the disk 15. The radial resonance frequency of these SBC devices 10 is approximately 86.5±0.5 kHz.

The displacement at the apex of the end cap 20 was measured for a ±2 kV/mm, 0.01 Hz triangular field using a spring loaded LVDT. The signal from the LVDT was monitored by a strain indicator and an electrometer connected to a computer. The LVDT was positioned on top of the endcap 20 with an XYZ stage. To eliminate the effects of the spring load on the displacement results, the LVDT was always positioned at a initial value of ˜750±2 μm (as read on the strain indicator) before applying the field. The displacement was recorded for 4 cycles and the response measured in the last cycle is the only value reported. The displacement was recorded for different pre-stress levels obtained by heating 110 the endcap 20 and monitoring the decrease in the cavity depth 30 with a dial micrometer 120.

Since all the measurements conducted involve destructive testing of the sample (tested until the PZT fails mechanically), each experiment used a different SBC sample 10 and the corresponding cavity depth 30 for failure varies for each sample 10 due to reasons discussed below. Typically, the sample 10 fails for a decrease in cavity depth 30 ranging between 100 to 275 μm. The results presented are representative of the three samples 10 that were evaluated.

A theoretical model was created to predict the magnitude of the stresses that are applied to the PZT member 15 by the shape memory endcaps 20 during the pre-stressing process by considering the lateral displacement achieved in the endcap 20. In this model, it is assumed that the metal endcap 20 is directly bonded to the PZT disk 15 forming a perfect bond; i.e., there is no appreciable bonding layer 35 between the endcap 20 and the PZT member 15. The implications of this assumption are discussed below. It is also assumed that the metal endcaps 20 are rigid, so that all lateral movement generated in the pre-stressing step is transferred to the PZT member 15. This model only offers a first order approximation of the stresses that are developed due to the nature of the above assumptions. FIG. 3A shows the typical cross section of a shape memory endcap 20 bonded to PZT member 15 before (solid lines 20A) and after (broken lines 20B) pre-stressing. FIG. 3B shows the triangular region formed by the cavity depth (d_{c}ⁱ) 30 and the difference between the radii at the apex and base of the cavity 33 for the shape memory endcap 20 prior to pre-stressing. From the endcap dimensions, the hypotenuse of the triangle can be calculated as:

$$h = \sqrt{{( {d}_{c}^{i} )}^{2} + {( \frac{{φ}_{b} - {φ}_{a}}{2} )}^{2}} \qquad ( 4 )$$

where d_{c}ⁱ is the initial cavity depth 30′, φ₀ is the cavity diameter 37′ at the base, and φ₂ is the cavity diameter 37″ at the apex. FIG. 3C corresponds to the triangular region under consideration after pre-stressing. It should be noted that the final cavity depth (dₑ^{f}) is lower than the cavity depth (d_{c}ⁱ) of the endcap before pre-stressing. Since the endcaps 20 are assumed to be rigid, it is reasonable to conclude that the hypotenuse is the same before and after pre-stressing. Therefore, the lateral displacement (Δφ) of the endcap 20 caused by the pre-stressing step can be calculated in a similar fashion using:

Δφ=°\sqrt{h²−(d_{c}^{f})²}−[(φ_{b}−φₐ)/2] (5)

This is also the lateral displacement of the PZT member 15 that is bonded to the shape memory endcap 20 because of the complete strain transfer that takes place in a perfect bond 55. Thus, the stress in the PZT member 15 may be calculated by using:

$$σ = \frac{Δφ}{( φ / 2 )} E \qquad ( 6 )$$

where σ is the stress, E is the Young's modulus of PZT (60 GPa), and φ is the diameter 37 of the PZT disk 15.

The theoretical stress applied to the PZT member 15 was calculated using equations 4 through 6 for different initial and final cavity depths 30 and a Young's modulus of 60 GPa for the PZT member 15. While this approach gives a general estimate of the magnitude of the lateral tensile stress, it neglects the stress relief associated with the partial depoling of the PZT disc 15 that would be anticipated. It is possible to use hysteresis loop data (see FIG. 7), the anisotropy of the PZT 15 (1.6%), and the extent of poling (72%), both measured here by x-ray diffraction to estimate the strain associated with depoling. Subtracting this strain from the total theoretical strain estimated from the decrease in cavity depth 30 yields a more accurate estimate of the stress level applied. The stress estimated through this approach is compared with the theoretical stress in FIG. 4, and the values observed do appear more realistic based on the known tensile strength of PZT materials 15 (50-70 MPa). Because depoling response is expected to be non-linear (vs. stress), the simple theoretical analysis that does not account for depoling still provides a starting point to employ measurements of cavity depth 30 as an estimate of stress development.

FIG. 4 shows the calculated theoretical stress applied to the PZT member 15 for different initial cavity depths 30 and the decrease in cavity depths 30 during pre-stressing. The final cavity depth 30 used in the calculations varies from 98 to 90% of the initial cavity depth 30. Stated otherwise, the decrease in cavity depth 30 ranges between 2 to 10% of the initial cavity depth 30. It can be observed that the applied stresses increases with a decrease in the cavity depth 30. In reality, these assumptions are useful but imperfect, insofar as the bond 35 is not perfect and the endcap 20 is not perfectly rigid, so not all lateral movement generated in the pre-stressing step is transferred to the PZT member 15. So, the actual stress will be lower than the stress predicted by this theoretical model.

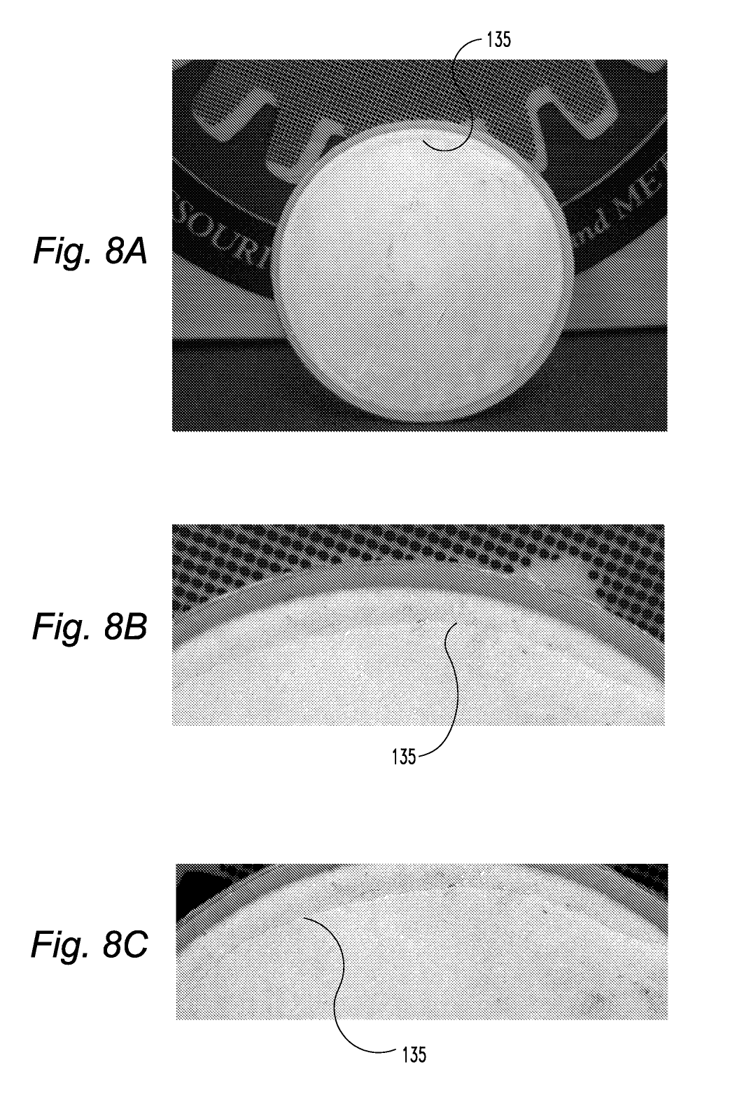

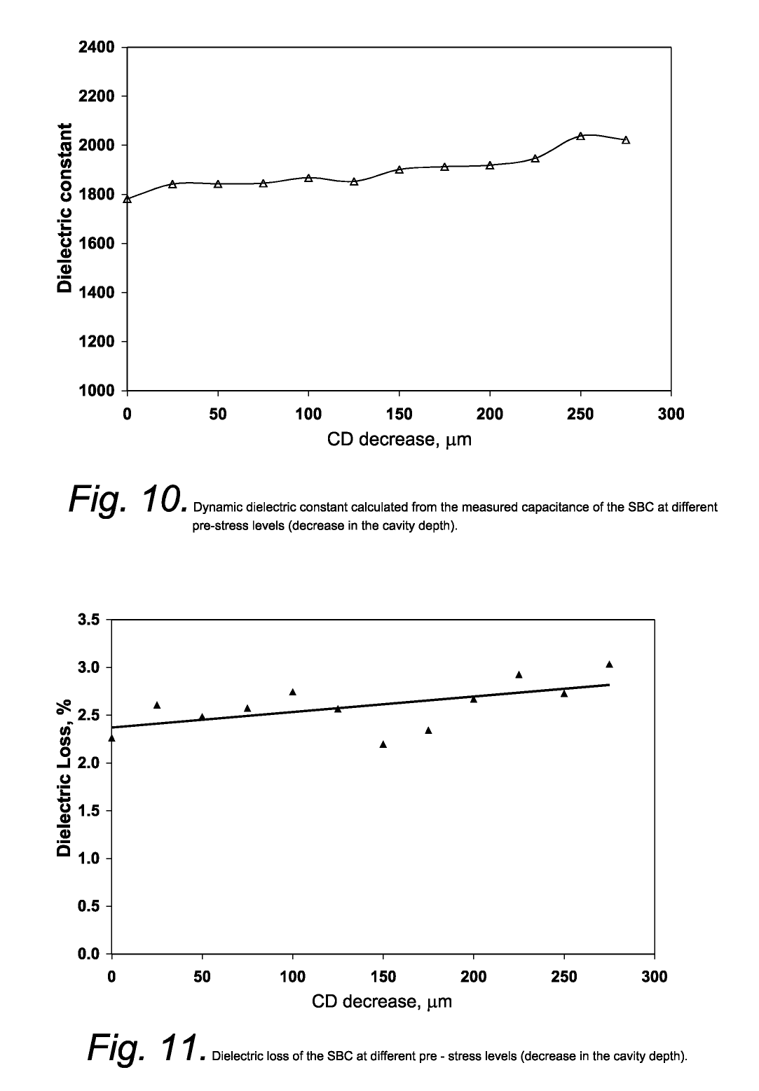

FIG. 5 shows the voltage measured across the 1 μF reference capacitor during the pre-stressing process as a function of time for three similar samples with an initial cavity depth of 1.45±0.13 mm. The sign of the measured voltage is negative, which according to equations 2 and 3 suggests that the stresses in the planar direction are tensile in nature. It should be noted that the voltage increases linearly with time and attains a peak voltage of approximately −6.5 to −6.8V, after which cracks 135 start to appear in the PZT member 15 (see FIGS. 8A-8C). This point is recognized by a characteristic dip in the measured voltage as the cracks 135 would have the effect of relieving some of the pre-stress induced by the deformation of the shape memory endcap 20. It should also be noted that although three similar samples were used for the experiments, the slope of the curves are different from one another. This behavior is attributed to the inconsistency in the thickness and the width of the cyanoacrylate bond 55, since it was applied to the flanges 40 of the endcaps 20 by hand and could not be effectively controlled.

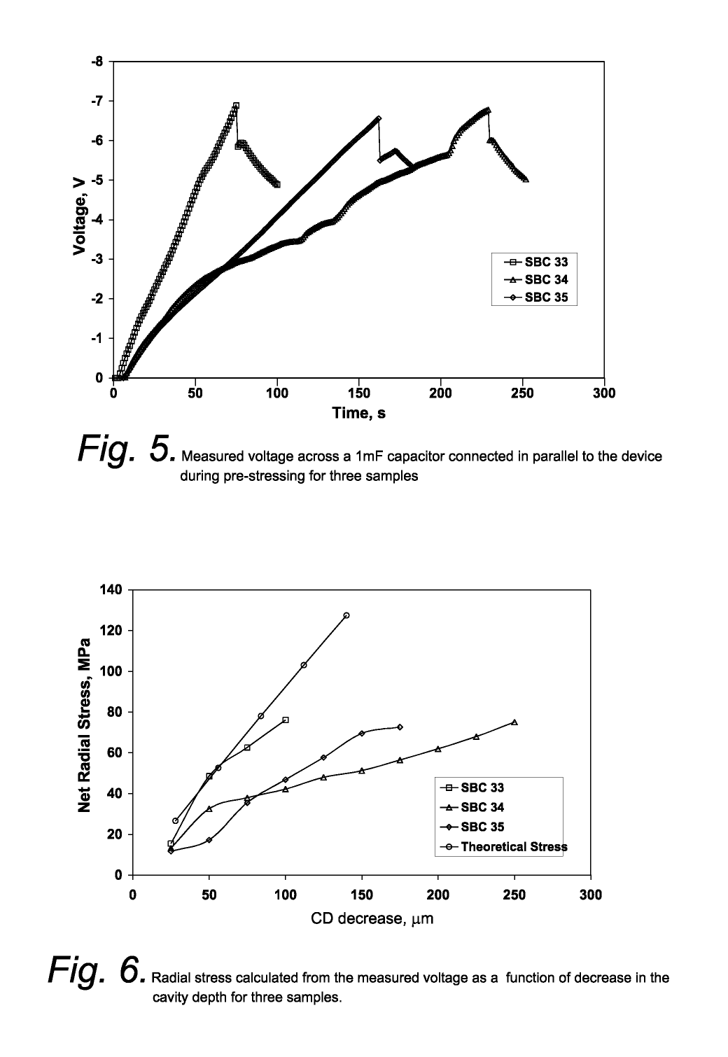

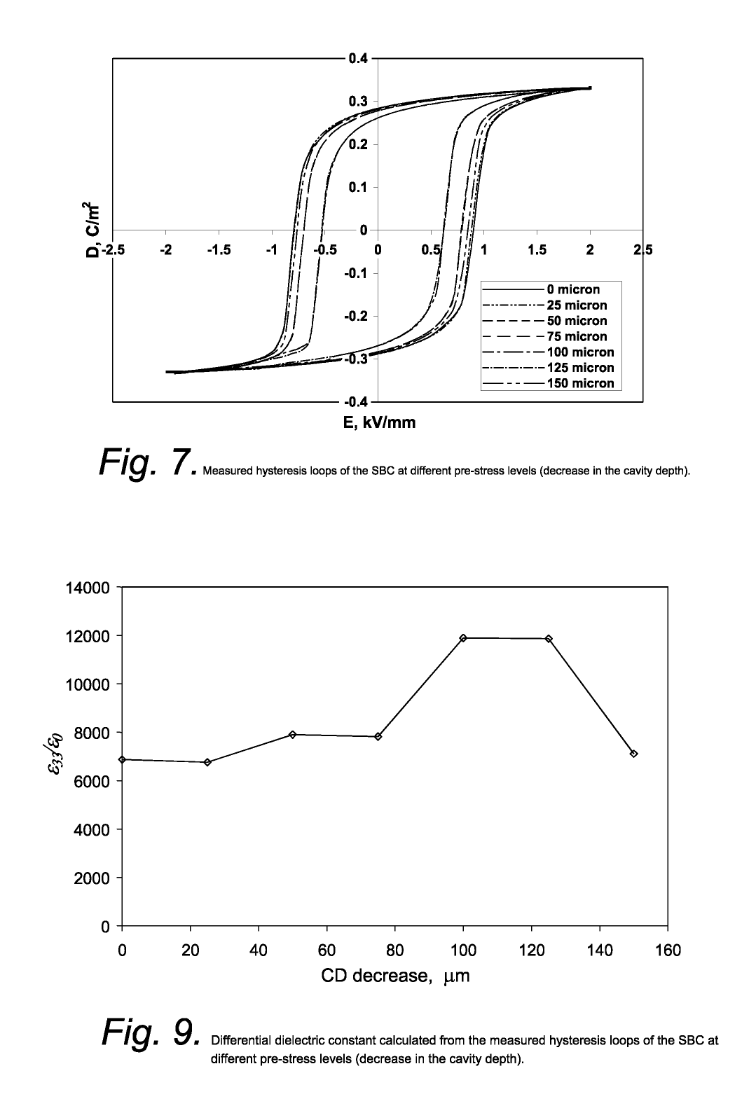

FIG. 6 shows the net radial stress as a function of the decrease in cavity 30 depth monitored with a dial micrometer for three different samples 10. The radial stress was calculated from the measured voltage using equations 2 and 3 and the reported value for d₃₁. It has been observed previously that the maximum stress soft PZT materials 15 can withstand before failure is ˜56-60 MPa. This value agrees well with the values observed in the present study. Although all the samples fail at approximately the same stress, they occur at different values of the final cavity depth 30. That is, for the three sample devices 10, the failure occurs for a decrease in the cavity depth 30 ranging between 100 and 250 μm. Again, this discrepancy is attributed to the inconsistency in the bond thickness and width, which is critical in transferring the stress from the shape memory endcap 20 to the PZT, member 15.

The calculated theoretical stress for d_{c}ⁱ=1.4 mm is also plotted in FIG. 6 to show the agreement with the measured values. The theoretical model agreed well with the measured values for sample SBC 33 for lower stresses, but not for higher stresses, at which depoling becomes more pronounced. Since the actual pre-stress applied on the PZT disk 15 varies from sample to sample, the remainder of the discussion below relates the properties measured to the decrease in the initial cavity depth 30 (proportional to pre-stress applied rather than the calculated stress).

The polarization vs. electric field (P-E) hysteresis loops of the SBC device 10 under different pre-stress magnitudes (directly proportional to the decrease in the cavity depth 30) are shown in FIG. 7. The area under the loop represents the unit volume polarization dissipation energy in a ferroelectric material. It can be observed that the area under the loop decreases with increasing stress (0 to 125 μm decrease in the cavity depth) suggesting that there are fewer domains that participate in the irreversible switching process. In the stress-free state, the dissipation energy is 0.964×10⁶ J/m³ and it decreases to 0.602×10⁶ J/m³ when the cavity depth 30 decreases by 100 μm. This is ˜37% lower than the stress-free state. A 36% decrease in the dissipation energy has been observed at ˜35 MPa uniaxial compressive stress (parallel to the poling direction) where the differential dielectric constant reached a maximum. FIG. 7 also shows that the remanent polarization decreases with increasing pre-stress. This behavior is attributed to the depolarization caused by the pre-stress, which is perpendicular to the poling direction. With increasing pre-stress, more domains are aligned orthogonal to the poling direction through 90° ferroelastic domain switching. Lastly, the coercive field, E_{c}, decreases with increasing stress levels indicating the electrical softening of the material under the stress conditions induced by the SMA endcap 20. Similar results in the changes of the remanent polarization and coercive field have been previously reported for increasing compressive load parallel to the poling direction of soft PZT's member 15.

In other words, the loss is due to the irreversible switching and the stress applied helps to reduce the number of domains that permanently switch to the direction of the field, as the stress urges the system back to its original state after the removal of the field. It also requires less electrical energy (because of the pre-stress) for the rest of the domains that do switch irreversibly decrease in Pr and Ec.

The PZT member 15 failed mechanically at approximately a 150 μm decrease in the cavity depth 30, thus releasing most of the developed pre-stress. A typical SBC sample device 10 after failure is shown in the inset in FIG. 7. The cracks 135 always appear parallel to the circumference, implying that the stresses are radial in nature. This failure point can be easily identified in the P-E response, where the hysteresis loop recovered most of its area compared to that of the original unstressed state. Although it recovered most of the area under the hysteresis loop, it still is less than the unstressed state suggesting the presence of residual stresses in the material, which are believed to be in the directions non-orthogonal to the crack 135.

The dielectric permittivity at different pre-stress levels (T) was approximately calculated using Eq. (7):

$${ɛ}_{33} ( T ) \approx \frac{Δ {D}_{3}}{Δ {E}_{3}} \qquad ( 7 )$$

The electric field range was selected between +0.1 kV/mm and −0.1 kV/mm because within such small range the calculated ε₃₃ is nearly equivalent to the slope of the P-E curve as the electric field passes through zero. This calculated dielectric permittivity is called as the differential permittivity, which includes both the intrinsic (reversible) and extrinsic (irreversible) contributions of the material response. In contrast, the dynamic dielectric permittivity often reported are measured with a small oscillating field and are largely dictated by the intrinsic contribution. Therefore, the stress-free differential dielectric constant (ε₃₃/ε₀) values estimated from the hysteresis loops are significantly higher than those measured dynamically using a low field alternating signal and an impedance bridge.

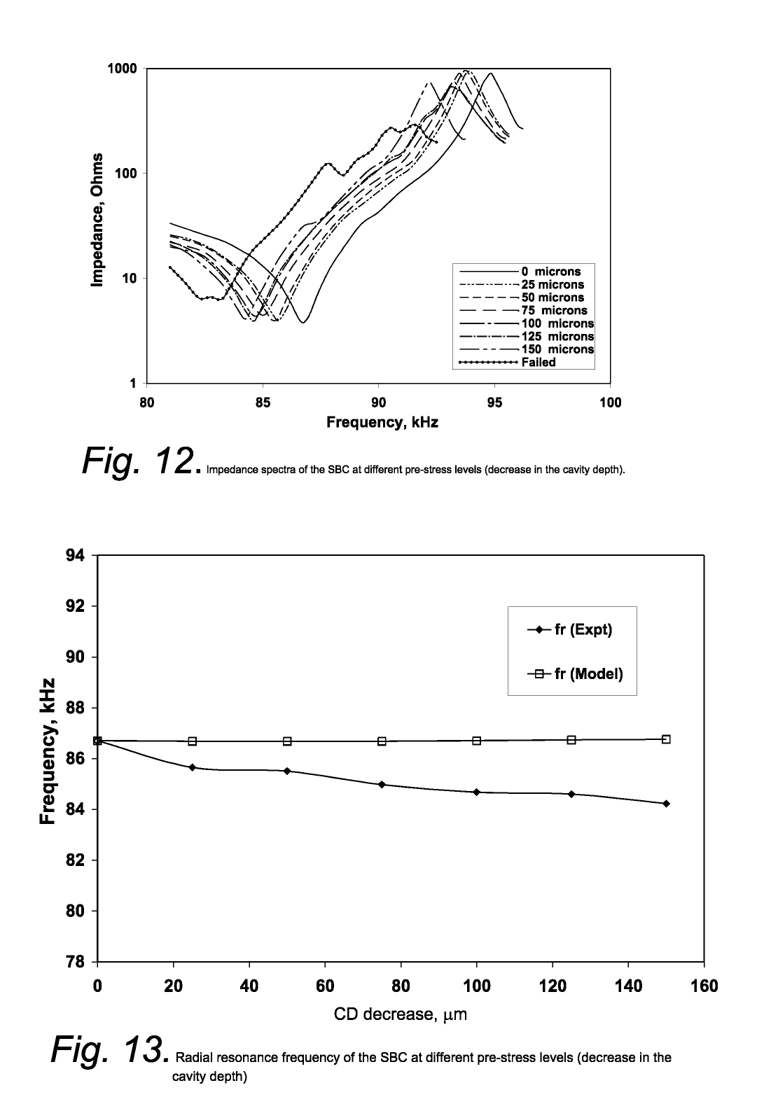

The change in the calculated differential dielectric constant from the slope of the hysteresis loops (FIG. 7) is shown in FIG. 9. The magnitude of the differential dielectric constant depends on the pre-stress level and generally increases with the magnitude of the pres-stress. The differential dielectric constant is ˜6,800 in the stress-free state compared to the dynamic dielectric constant of ˜1,780 at 1 kHz. It can be observed from FIG. 9 that the dielectric constant increases with pre-stress until failure of the PZT member 15 at approximately a 150 μm decrease in the cavity depth. An approximate 75% increase in the dielectric constant was observed by pre-stressing the PZT member 15 radially. This suggests that domain wall translational processes are more dominant in the pre-stressed SBC device 10. This behavior is in complete agreement with reports published on the dielectric response under uniaxial compressive stress parallel to the poling direction, where an enhancement in the value of the differential dielectric constants of more than 100% has been reported for soft PZT materials.

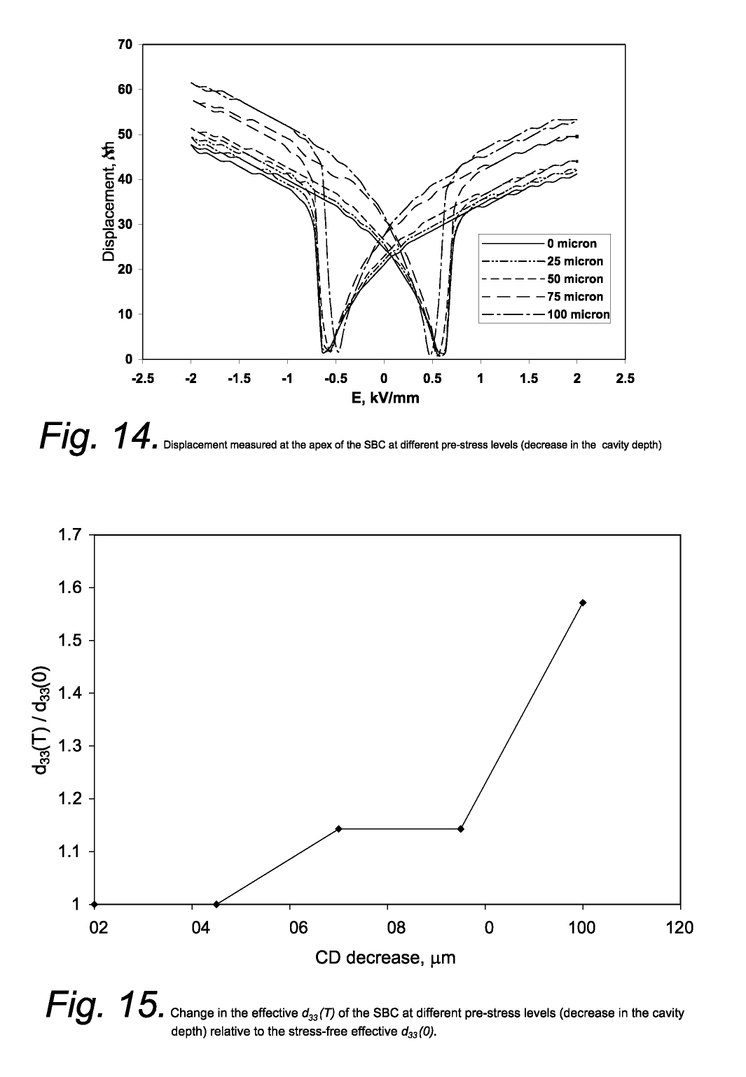

As is illustrated in FIGS. 10 and 11, the dielectric constant calculated from the measured capacitance at 1 kHz increased monotonically from ˜1,780 in the stress-free state to ˜2,035 for a decrease in the cavity depth 30 of ˜250 μm, after which the PZT failed mechanically (at 275 μm) and a decrease in the dielectric constant was observed. Since the dynamic dielectric permittivity is dictated mainly by the intrinsic contribution due to the low applied field, only a 14% increase in the dielectric constant is observed. The device 10 exhibited a slight increase in dielectric loss with increasing pre-stress because of increased domain wall motion, increasing from 2.2% in the stress-free state to a maximum of 3.0% before failure. All of these observations suggest increased domain switching and/or domain wall translational contributions to the response.

The impedance spectra and the shift in radial resonance frequency of the SBC devices 10 under different decreases in cavity depth are shown in FIG. 13. As expected, the radial resonance and anti-resonance frequencies decrease with increasing pre-stress level. This result suggests a decrease in the elastic constant of the PZT layer 15, as would be anticipated for greater domain wall translation. The radial resonance frequency was ˜86.7 kHz in the stress-free state and it decreased to ˜84.2 kHz for a decrease in cavity depth 30 of ˜150 μm. It is also worth noting that impedance spectroscopy has also been extensively used to detect cracks 135 in the samples since it is sensitive to flaws. This characteristic can also be seen in this figure for the sample that failed. Various stray resonances begin to occur and the impedance spectrum becomes noisy due to the presence of cracks 135.

Although the decrease in the radial resonance frequency is believed to be caused by the softening of the material 15 due to the pre-stress, as noted above, the effects of the decrease in the cavity depth 30 on the radial resonance frequency of the device 10 cannot be completely ignored. Therefore, the effects caused by the pre-stress and the decrease in the cavity depth 30 of the endcap 20 have to be decoupled to properly interpret the results of this figure.

To further understand the effect of the decrease in the cavity depth 30 of the SBC 10, 2D axisymmetric finite element models were created using commercially available software to predict the radial resonance frequency. Complete details about the 2D axisymmetric models of cymbals are reported elsewhere and complete agreement between the predicted and measured values have been reported previously. Consequently, finite element modeling was considered as a viable option to decouple these two effects on the radial resonance frequency. The 2D model consisting of a PZT disk 15, bond layer 55 and SMA endcap 20 represents the SBC 10 under zero pre-stress i.e., an SBC 10 under zero pre-stress is a standard cymbal device. Therefore, the finite element simulation of cymbals 10 with different cavity depths 30 will give information on the change in the predicted radial resonance frequency as a function of decrease in the cavity depth 30. Since the Young's modulus values of the SMA endcap 20 is highly dependent on the material annealing (28-41 GPa for martensite and 60-90 GPa for austenite), and the stress-strain history of the material, estimates of the modulus were determined by adjusting the input values in the model until the simulated resonance frequency matched the experimentally observed value of 86.70 kHz for the SBC 10 under zero pre-stress (see FIG. 13). This Young's modulus was then used to simulate the resonance frequency of cymbals 10 with different cavity depths 30. The model predicts an increase in the radial resonance frequency of 0.06 kHz for a decrease in the cavity depth 30 of ˜150 μm as opposed to the observed decrease in the measured value of 2.5 kHz. From this, it can be concluded that, although the two effects oppose each other, the effect of the cavity depth 30 on the radial resonance frequency of the SBC 10 can be neglected and the observed behavior in FIG. 13 can be purely attributed to the electrical softening of the material due to the pre-stress.

The displacement measured at the apex of the endcap 20 as a function of electric field for different pre-stress levels is shown in FIG. 14. It can be clearly observed that the pre-stress applied by the shape memory endcap enhances the displacement response of the devices 10. The maximum displacement at −2 kV/mm in the stress-free state is ˜47.5 μm, whereas it increased to ˜61.5 μm for a decrease in the cavity depth 30 of ˜100 μm. This represents an approximate 30% increase in the displacement due to pre-stress. Both the remanent strain and the strain at saturation increases with stress because strain was measured at the surface of the endcap 20. It is also evident from FIG. 14 that the coercive field decreases with increasing pre-stress level due to the electrical softening of the material 15 caused by the pre-stress.

The effective d₃₃ was estimated at different pre-stress levels (T) by measuring the slope of the butterfly loops in the ±0.1 kV/mm field range with the following equation

$${d}_{33} ( T ) \approx \frac{Δ {x}_{3}}{Δ {E}_{3}} \qquad ( 8 )$$

where, Δx₃ is the change in strain in the direction of poling. FIG. 15 shows the relative effective d₃₃, i.e., the d₃₃(T)/d₃₃(0) ratio as a function of pre-stress level. As expected the effective d₃₃ increases with increasing pre-stress levels reaching a maximum of ˜57% higher than the stress-free device 10 for a decrease in the cavity depth 30 of 100 μm. The sample failed at approximately 125 μm decrease in the cavity depth 30.

A novel method of pre-stressing the cymbal flextensional transducer 10 using shape memory alloys 25 was employed and these devices 10 are called stress-biased cymbals (SBC). Pre-stressing the piezoelectric disk 15 radially in tension enhanced the 90° domain wall motion contributions to electromechanical response, as suggested by the increased dielectric and strain response of the cymbal device 10. The differential dielectric constant increased by ˜70% and the effective d₃₃ increased by ˜57% due to pre-stressing. The dynamic dielectric constant increased only by ˜14% and the dielectric loss increased only by ˜10% (from 2.4% to 2.7% loss) due to the low oscillating fields used in those measurements. The radial resonance frequency of the SBC device 10 decreased by 2.5 kHz (˜3%) with increasing pre-stress levels indicating the decrease in the elastic constants of the material 15.

### EXAMPLE 1

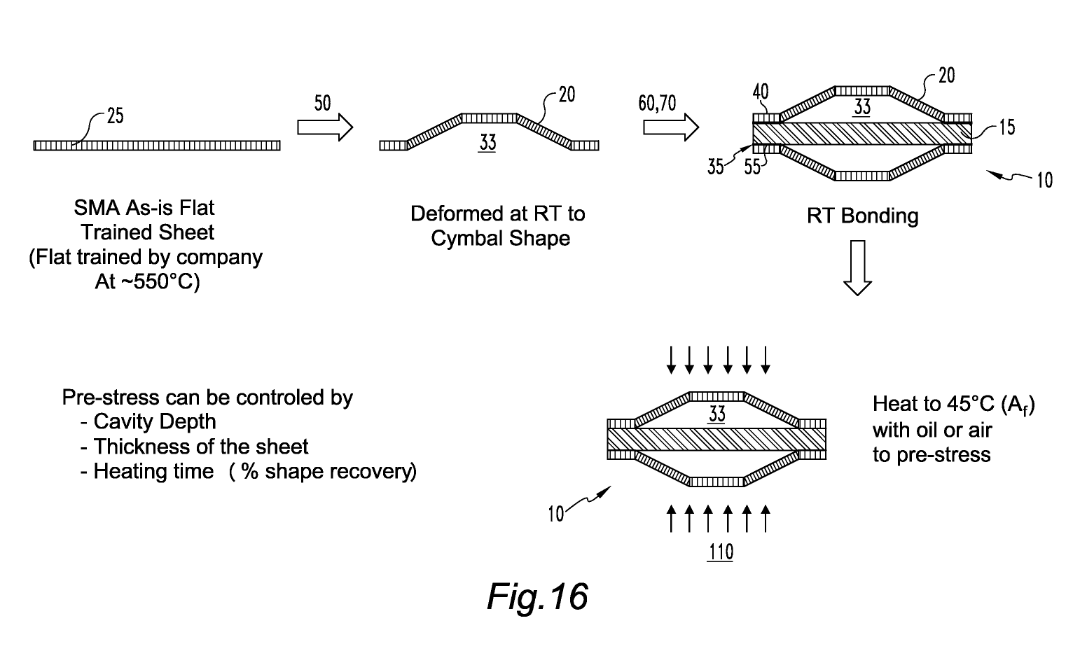

As illustrated in FIG. 16, one aspect of the novel technology relates to a method of pre-stressing the electroactive element 15 using cymbal endcaps 20 made of shape memory alloy precursers 25. A flat trained SMA 25, with an austenite finish temperature (A_{f}) of approximately 45° C., was formed 50 into acymbal shaped endcap 20. After bonding 70 the endcap 20 to the PZT disk 15, the device 10 was heated 75 slightly above the Af to recover the flat trained shape of the SMA; i.e., the cavity depth 30 of the end cap 20 decreases. This shape recovery process is opposed by the bond 55 between the flanges 40 of the endcap 20 and the PZT disc 15, resulting in a radial tensile stress in the PZT disk 15. It is shown that this pre-stress enhances the 90° domain switching, thus increasing the piezoelectric and dielectric response of cymbal-like devices 10. The magnitude of the radial stress can be controlled by the heating time (which varies the final cavity depth), initial cavity depth and thickness of the SMA 25. A flat trained 0.25 mm thick Nitinol sheet 25 with an austenite finish temperature of ˜45° C. and pre-poled PZT disks 15 25 mm in diameter and 0.2 mm in thickness were used in this particular example. The piezoelectric disks 15 are typically made of compositions near the vicinity of the morphotropic phase boundary of PZT in the tetragonal phase, with performance characteristics similar to PZT 5A compositions, as known in the current art. The cymbal shape for the endcap 20 was attained by stamping and cutting 50 the 0.25 mm thick nitinol sheet 25 in a specially designed steel die. The flanges 40 of the metal endcap 20 and the surface of the electrodes on the PZT disk were roughened 60 with a 400 grit SiC abrasive paper to improve the bond strength. After the surface preparation, both the shape memory cap 20 and the PZT 15 were cleaned with acetone to remove the residual metal and SiC particles. Cyanoacrylate was then applied to the flanges directly from the tip of the container, to achieve bonding 50. The endcap 20 was then assembled with the PZT 15 and cured under a load of approximately 50N applied to the flanges 40 during curing at room temperature. The PZT disk 15 was laid flat on a plastic sheet to avoid the excess bonding material flowing to the surroundings. The excess glue was then removed with a blade. All the devices 10 of this study were fabricated with a single endcap 20, as opposed to the two endcaps 20 used in the standard cymbals, because of the ease in measuring the decrease in the cavity depth 30 (pre-stress developed) of a device 10 with one endcap 20 following the shape memory alloy transformation. Devices with two endcaps 20 can be manufactured in a similar fashion.

### EXAMPLE 2

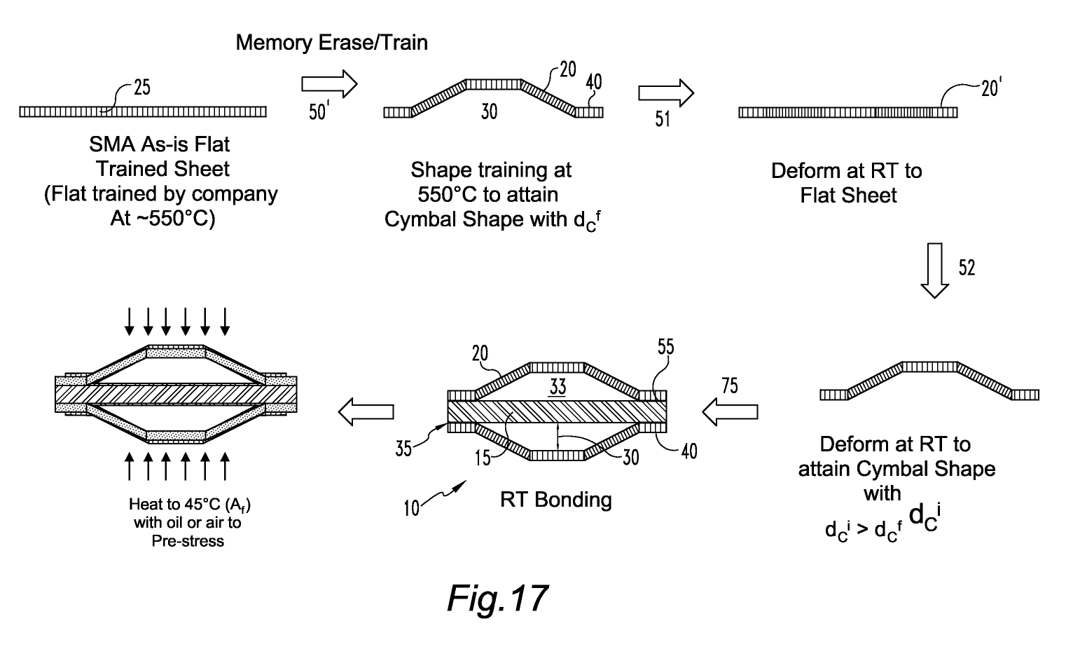

FIG. 17 illustrates another embodiment of the novel technology, a method of producing a flextensional transducer device 10 by pre-stressing the electroactive element 15 using pre-trained 50′ cymbal endcaps 20 formed from an SMA 25. Pre-training 50′ the endcap shape yields an endcap 20 having a predetermined cavity depth 30 d_{c}^{f} at a predetermined temperature (such as, for example, ˜550° C.) such as through the use of special dies. After shape training 50′ at the predetermined training temperature, the endcap 20 is then flattened 51 at room temperature first with mechanical pressure, followed by stamping 52 to give a cymbal endcap shape with cavity depth 30 d_{c}ⁱ. Typically, cavity depth 30 d_{c}ⁱ>d_{c}^{f}. Next, the endcap 20 is bonded 75 to the PZT disk 15 to yield a flextensional transducer device 10; the bond 35 is typically formed between the flange 40 and the electrode 55 formed on the disc 15. When the device 10 is heated 110 above A_{f}, the cavity depth 30 will decrease from d_{c}ⁱ to d_{c}^{f}, thus pre-stressing the PZT disk 15 and this difference (d_{c}ⁱ-d_{c}^{f}) can be predetermined by selection of the amount of pre-stress required for an application.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A flextensional transducer, comprising in combination:
a generally disc-shaped piezoelectric member having a generally flat top surface and a generally flat parallel bottom surface;
a top electrode formed on the top surface;
a bottom electrode formed on the bottom surface;
a top endcap operationally connected to the top surface; and
a bottom endcap operationally connected to the bottom surface;
wherein the top and bottom endcaps are formed of shape memory material; and
wherein the endcap exerts a radial stress upon the generally disc-shaped piezoelectric member.

2. The transducer of claim 1 wherein the radial stress on the disc-shaped piezoelectric member yields an increase in its dielectric constant by at least about 50%.

3. The transducer of claim 1 wherein the radial stress on the disc-shaped piezoelectric member yields an increase in its dielectric constant by at least about 70%.

4. The transducer of claim 1 wherein the radial stress on the disc-shaped piezoelectric member yields an increase in its displacement response of at least about 30%.

5. The transducer of claim 4 wherein the radial stress on the disc-shaped piezoelectric member yields an increase in its domain wall translation contribution to displacement response.

6. The transducer of claim 1 wherein each respective endcap is bonded to a respective electrode and wherein each respective electrode is bonded to a respective surface.

7. A method of making a flextensional transducer device, comprising:
a) configuring a piece of shape memory material having an initial shape into a first endcap having a final shape;
b) coupling the first endcap to a piezoelectric member; and
c) initiating recovery of the initial shape of the shape memory material;
wherein recovery of the initial shape of the shape memory material generates radial stresses in the piezoelectric member.

8. The method of claim 7 wherein the piezoelectric member is pre-poled.

9. The method of claim 7 wherein 90 degree domain switching of the piezoelectric member is substantially enhanced by the radial stresses generated therein.

10. The method of claim 7 wherein the dielectric constant of the piezoelectric member is substantially enhanced by the radial stresses generated therein.

11. The method of claim 7 and further comprising:
d) forming an electrode layer on the piezoelectric member; and
e) bonding the first endcap to the electrode layer.

12. The method of claim 7 and further comprising:
f) configuring a second piece of shape memory material having an initial shape into a second endcap having a final shape; and
g) bonding the second endcap to the piezoelectric member opposite the first endcap.

13. The method of claim 7 wherein the shape memory material is nitinol and wherein the piezoelectric member is a PZT.

14. The method of claim 7 wherein the piezoelectric material is near it morphotropic phase boundary at standard temperature and pressure.

15. A method of making a transducer device, comprising:
a) forming a pair of endcaps from shape memory material, wherein the shape memory material has an initial shape and the endcaps define a final shape;
b) coupling the endcaps to opposite sides of a generally flat piezoelectric member to define a transducer device; and
c) inducing radial stresses in the piezoelectric material to yield a pre-stressed flextensional transducer device;
wherein recovery of the initial shape of the endcaps induces radial stress in the piezoelectric member.

16. The method of claim 15 wherein the shape memory material is nitinol and wherein the piezoelectric member is substantially PZT.

17. The method of claim 15 wherein the induction of radial stress is accomplished by exposing the endcaps to conditions sufficient to initiate a shift from their final shape towards their initial shape.

18. The method of claim 17 wherein the endcaps are nitinol and the conditions include an increase in temperature to at least about 45 degrees Celsius.

19. The method of claim 15 wherein induction of radial stresses in the piezoelectric member is accompanied by an increase in its dielectric constant of at least about 70%.

20. The method of claim 15 wherein the induction of radial stress on the piezoelectric member yields an increase in its displacement response of at least about 30%.

21. The transducer of claim 15 wherein the induction of radial stress on the piezoelectric member yields a substantial increase in the efficiency of the flextensional transducer device.

22. The transducer of claim 15 wherein the induction of radial stress on the piezoelectric member yields an effective increase in d₃₃ piezoelectric charge coefficient of at least about 50%.
